(19) United States
(12) Patent Application Publication
(10) Pub. No.: US 2023/0047835 A1
(43) Pub. Date: Feb. 16, 2023

(54) METHOD FOR MAKING POROUS FILTER MEMBRANES

(71) Applicant: ETH Zurich, Zurich (CH)

(72) Inventor: Karl-Philipp SCHLICHTING, Zürich (CH)

(73) Assignee: ETH Zurich, Zurich (CH)

(21) Appl. No.: 17/780,387

(22) PCT Filed: Nov. 17, 2020
(86) PCT No.: PCT/EP2020/082370

§ 371 Date: May 26, 2022

(30) Foreign Application Priority Data
Nov. 28, 2019 (EP) 19212143.2

(51) Int. Cl. B01D 71/02; B01D 67/00; B01D 69/02; B01D 53/22; B01D 61/24

(52) U.S. Cl. CPC B01D 71/0211; B01D 67/0072; B01D 67/009; B01D 69/02; B01D 53/228; B01D 61/243; B01D 67/0083; B01D 2256/16; B01D 2257/11; B01D 2257/504; B01D 2325/02831; B01D 2325/02832; B01D 2323/081; B01D 2323/10; B01D 2325/027; B01D 2325/02833; B01D 2323/28; B01D 2323/64; B01D 2323/34; B01D 2257/7025

(57) ABSTRACT

A method for producing a nano-porous membrane with one or up to four graphene layers, pores in the membrane having an average pore size in the range of 0.2-50 or 0.3-10 nm, wherein the method involves the following steps: a) generation of a contiguous, essentially non-porous membrane with one or up to four graphene layers; b) distributed point wise defect creation in the non-porous membrane with one or up to four graphene layers by way of irradiation; c) generation and successive growth of the pores at the defects generated in step b) by thermal annealing in the gas phase, e.g. under 02 at a temperature in the range of 250° C. to less than 400° C.

### TECHNICAL FIELD

The present invention relates to methods for making porous filter membranes based on single or few-layer graphene. It also relates to porous (gas) filter membranes obtained using such a method as well as to uses of such membranes for filter purposes.

### PRIOR ART

Separating gases using membranes promises substantial energy savings over phase change based processes. To harvest the potential energy savings of membranes, transport across the membranes should be maximized in order to enable high process throughput. Typically, transport increases with thinner membrane materials, such that graphene is considered promising. In its pristine state graphene is, however, impermeable to any gas molecule, such that pores need to be introduced to create a functional membrane. Various processes have been developed to create pores within the graphene crystal, which can be classified into serial and parallel processes for pore fabrication. The high number of pores required for any practical membrane makes serial process (Focused Ion Beam, TEM, e-beam assisted, . . . ) industrially unattractive. Parallel processes on the other hand are promising in terms of scalability for larger membrane areas. However, the pore sizes required for achieving attractive gas separation performance are not attainable for processes based on particle-assisted patterning of graphene (Block copolymer (BCP) self-assembly, W-Nanoparticles, Pt-Nanoparticles) and processes without particle-assisted patterning create defects into the pristine graphene in a non-selective manner such that pore number and size cannot be controlled independently (UV-assisted, Ozone, plasma). While these non-selective approaches have recently demonstrated significant progress toward high gas selectivity and permeance it remains desirable to develop a process that allows independent control of pore density and size. Such independent control paves way for narrower pore size distributions and allows independent optimization of pore number and density leading to an overall enhanced membrane performance. Furthermore, independent control of pore number and size may promise a universal graphene membrane fabrication technique that can provide membranes for different separation applications depending on pore size and porosity.

O'Hern et al (Nano Lett. 2014, 14, 1234-1241) report selective ionic transport through controlled, high-density, sub-nanometer diameter pores in macroscopic single-layer graphene membranes. Isolated, reactive defects were first introduced into the graphene lattice through ion bombardment and subsequently enlarged by oxidative liquid etching into permeable pores with diameters of 0.40±0.24 nm and densities exceeding 10¹² cm⁻², while retaining structural integrity of the graphene. Transport measurements across ion-irradiated graphene membranes subjected to in situ etching allegedly revealed that the created pores were cation-selective at short oxidation times, consistent with electrostatic repulsion from negatively charged functional groups terminating the pore edges. At longer oxidation times, the pores allowed transport of salt but prevented the transport of a larger organic molecule, indicative of steric size exclusion. The ability to tune the selectivity of graphene through controlled generation of sub-nanometer pores addresses a significant challenge in the development of advanced nano-porous graphene membranes for nano-filtration, desalination, gas separation, and other applications.

Problematic in relation with this technology is inter alia the fact that the number of pores is increasing as a function of time of the chemical liquid etching, showing that pores are not only created where defects have been forced. Therefore, the process proves to be unreliable for the creation of a well determined number of pores and well determined size and density of pores. These properties are however crucial for the selectivity in filter applications. Furthermore, chemical liquid etching has the drawback of contamination of the membrane and upon removal of the liquid due to the drying process (capillary forces) the graphene has the tendency to tear up.

Wang et al (Nature chemistry|Vol 2|Aug. 2010, p661ff) report that conventional lithography can only reliably pattern ˜20-nm-wide narrow graphene nanoribbon (GNR) arrays limited by lithography resolution, while sub-5-nm GNRs are desirable for high on/off ratio field-effect transistors at room temperature. They devised a gas phase chemical approach to etch graphene from the edges without damaging its basal plane. The reaction involved high temperature oxidation of graphene in a slightly reducing environment in the presence of ammonia to afford controlled etch rate. They fabricated ˜20-30-nm-wide graphene nanoribbon arrays lithographically, and used the gas phase etching chemistry to narrow the ribbons down to <10 nm. A high on/off ratio up to ˜10⁴ was achieved at room temperature for field-effect transistors built with sub-5-nm-wide graphene nanoribbon semiconductors derived from lithographic patterning and narrowing. Our controlled etching method opens up a chemical way to control the size of various graphene nano-structures beyond the capability of top-down lithography.

Geng et al (J. Am. Chem. Soc. 2013, 135, 6431-6434) reports that an anisotropic etching mode is commonly known for perfect crystalline materials, generally leading to simple Euclidean geometric patterns. This principle has also proved to apply to the etching of the thinnest crystalline material, graphene, resulting in hexagonal holes with zigzag edge structures. They demonstrate that the graphene etching mode can deviate significantly from simple anisotropic etching. Using an as grown graphene film on a liquid copper surface as a model system, they show that the etched graphene pattern can be modulated from a simple hexagonal pattern to complex fractal geometric patterns with six-fold symmetry by varying the Ar/H₂ flow rate ratio. The etched fractal patterns are formed by the repeated construction of a basic identical motif, and the physical origin of the pattern formation is consistent with a diffusion-controlled process. The fractal etching mode of graphene presents an intriguing case for the fundamental study of material etching.

Thomsen et al (ACS Nano 2019, 13, 2281-2288) studied the oxidation of clean suspended mono- and few-layer graphene in real time by in situ environmental transmission electron microscopy. At an oxygen pressure below 0.1 mbar, they observe anisotropic oxidation in which armchair-oriented hexagonal holes are formed with a sharp edge roughness below 1 nm if the reaction is carried out at elevated temperatures in the range of 800-1300° C. At a higher pressure, they observe an increasingly isotropic oxidation, eventually leading to irregular holes at a pressure of 6 mbar. In addition, they find that few-layer flakes are stable against oxidation at temperatures up to at least 1000° C. in the absence of impurities and electron-beam-induced defects. These findings show, first, that the oxidation behavior of mono- and few-layer graphene depends on the intrinsic roughness, cleanliness and any imposed roughness or additional reactivity from a supporting substrate and, second, that the activation energy for oxidation of pristine suspended few-layer graphene is up to 43% higher than previously reported for graphite. Also, it shows that high temperatures in the range of 800-1300° C. are required of etch opening defects to form pores. In addition, they have developed a cleaning scheme that results in the near-complete removal of hydrocarbon residues over the entire visible sample area. These results have implications for applications of graphene where edge roughness can critically affect the performance of devices and more generally highlight the surprising (meta)stability of the basal plane of suspended bilayer and thicker graphene toward oxidative environments at high temperature.

Choi et al (“Multifunctional wafer-scale graphene membranes for fast ultrafiltration and high permeation gas separation”, Sci. Adv. 2018;4) report reliable and large-scale manufacturing routes for perforated graphene membranes in separation and filtration. Two manufacturing pathways for the fabrication of highly porous, perforated graphene membranes with sub-100-nm pores, suitable for ultrafiltration and as a two-dimensional (2D) scaffold for synthesizing ultrathin, gas-selective polymers are presented. The two complementary processes-bottom up and top down-enable perforated graphene membranes with desired layer number and allow ultrafiltration applications with liquid permeances up to 5.55×10⁻⁸ m³ s⁻¹ Pa⁻¹ m⁻². Moreover, thin-film polymers fabricated via vapour liquid interfacial polymerization on these perforated graphene membranes constitute gas-selective polyimide graphene membranes as thin as 20 nm with superior permeances. The methods of controlled, simple, and reliable graphene perforation on wafer scale along with vapor-liquid polymerization allow the expansion of current 2D membrane technology to high-performance ultrafiltration and 2D material reinforced, gas-selective thin-film polymers. Buchheim et al. (“Assessing the Thickness-Permeation Paradigm in Nanoporous Membranes”, ACS NANO, vol. 13 , no. 1, 2019), WO-A-2013/138698, EP-A-3 539 644, EP-A-3 254 750, US-A-2018/290108, WO-A-2016/011124 as well as CN-A-108 467 030 relate to porous graphene membranes in general.

### SUMMARY OF THE INVENTION

In this application, we propose a dry, facile, scalable graphene membrane fabrication using a two-step process allowing independently controlling pore size and poring number with narrow pore size distributions. Energetic ion irradiation creates artificial defects in single or few layer, preferably double layer graphene membranes, and defines the number of pores of the porous final membranes. Selective gas phase etching in oxygen or hydrogen of the graphene defects and pore edges allows controlling the pore size in a second process step. The resulting membranes show log-normal pore diameter distributions with controlled mean diameters ranging from sub-nm to 10 nm and absence of outliers from the respective pore diameter distributions.

Experimentally, the transport of gas molecules across porous graphene of various pore sizes has been studied demonstrating molecular sieving for sub-nm sized pores, and the transition from effusive to continuum flow theory for pore sizes above 7 nm up to 1000 nm. A relation of gas permeation and selectivity of a given pore size has not been established yet. Hence, study of the transport mechanisms across graphene nano-pores of different sizes remains elusive. There is a need to have narrow pore size distributions and control over pore numbers to get a better understanding of transport physics and permeability as well as selectivity for certain pore sizes.

The narrow pore diameter distribution and control over pore number demonstrated here enable probing the gas transport characteristics across nano-porous graphene membranes using mass spectroscopy. The developed fabrication process allows fabricating membranes showing molecular sieving of gas mixtures at competitive permeabilities as well as high permeability membranes at similar selectivity to state-of-the-art graphene membranes at up to two orders of magnitude higher permeability.

Inter alia, double layer graphene (DLG) membranes were fabricated from commercial chemical vapor deposited graphene and transferred to a porous Si₃N₄ support membrane resulting in a defined array of circular holes over which freestanding DLG is suspended. Using DLG instead of SLG increases transfer yield of the membranes and additionally reduces possible leakage pathways through intrinsic defects within the graphene. Each membrane was imaged by SEM at various magnifications to rule out ruptures in the membrane area, statistically account for potential presence of SEM-detectable pinholes or defects, as well as pore diameter and density quantification.

More specifically, the proposed invention relates to a method for producing a nano-porous membrane with one or up to four graphene layers. The pores in the membrane have an average pore diameter in the range of 0.2-50 nm, preferably 0.3-10 nm. The average pore diameter according to this invention is determined as follows: the arithmetic mean of the areas of the pores is determined in a predetermined observation area of the membrane (typically in the range of 8-8 μm²). Then this value of the arithmetic mean of the pore areas is converted into the average pore diameter by calculating the average diameter a circle of this average area would have (D=2*sqrt(A/pi)). Pore diameters below 3 nm diameter can also be determined using transmission electron microscopy that allows resolution of pores down to the limit of ca. 0.2 nm. An alternative method to determine pore diameters below 1 nm utilizes the analysis of gas separation experiments based on the measured selectivity for various gas types. For selectivities higher than the square-root of the inverse of the molecular weight ratio (sqrt(M₁/M₂)⁻¹) of the involved gases, the average pore diameter is smaller than the kinetic diameter of the larger gas. For example, 15 min oxygen etching with the proposed method leads to gas selectivities for H₂/CO₂ of 6.70, which is higher than the square-root of the inverse of the molecular weight ratio of the gases ((M(CO₂)/(M(H₂))^{-0.5}=(44/2)^{-0.5}=4.69) (FIG. 4c). Therefore, the pores after 15 min O₂ etching with the proposed are smaller than the kinetic diameter of CO₂, which is 0.33 nm. At the same time, pores after 15 min O₂ etching separate H₂/He with a value of 1.36, which is slightly lower than the square-root of the inverse of the molecular weight ratio ((4/2)^{-0.5}=1.44) (FIG. 4c). Thus, the pores are larger than H₂, which has a kinetic diameter of 0.289 nm. Consequently, 15 min oxygen etching with the proposed method leads to pores with diameters in the range of 0.289-0.330 nm. Corresponding pores of the same size produced with H₂ etching show the same behavior.

The proposed method comprises at least the following steps:

a) generation of a contiguous, essentially non-porous membrane with one or up to four graphene layers;

b) distributed point wise defect creation in said non-porous membrane with one or up to four graphene layers by way of irradiation;

c) generation and successive growth of said pores at the defects generated in step b) by thermal annealing in the gas phase, preferably for O₂ or H₂ etching, e.g. in case of O₂ etching at a temperature in the range of 250° C. to less than 400° C. and for H₂ etching at a temperature in the range of 400° C. to less than 750° C.

According to a first preferred embodiment, the average pore diameter of the pores in the nano-porous membrane is in the range of 0.2-10 nm, preferably in the range of 0.2-8 nm. The proposed process is particularly suitable for tailor-made average pore diameters in this range, and these pore diameters allow for advantageous filter applications as detailed further below.

According to yet another preferred embodiment, the pore density in the nano-porous membrane is in the range of up to up to 10^{17 m-2,} preferably in the range of 10¹² m⁻²-10¹⁷ m⁻² or in the range of 10¹² m⁻²-10¹⁶m⁻².

According to yet another preferred embodiment, the pore diameter probability distribution expressed in a Log-normal distribution following the equation:

$$P = \frac{1}{\sqrt{2 π} σ D} exp ( - \frac{( ln ( D ) - μ ) \hat{} 2}{2 {σ}^{2}} )$$

wherein P is the probability and D is the pore diameter in nm, exp(μ) is the median pore diameter and exp(p+0.5a²) is the mean pore diameter. Preferably, the value p is in the range of -1.5-2.4, preferably in the range of −1.2-2.2 or −1-1.6, and/or the value of a is smaller than 0.6, preferably in the range of 0.2-0.6, or in the range of 0.3-0.55 or 0.4-0.5.

The step of thermal annealing in step c) preferably takes place either at a temperature in the range of 250° C. to less than 400° C. under an oxygen atmosphere with a partial oxygen pressure of less than 5 mbar, preferably in the range of 0.1-4 mbar, most preferably in the range of 0.8-1.5 mbar or at a temperature in the range of 400° C. to less than 900° C., preferably in the range of 600-750° C., under a hydrogen atmosphere with a partial H2 pressure of less than 5 mbar, preferably in the range of 0.01-1 mbar, most preferably in the range of 0.1-0.3 mbar, preferably while being mounted on a metal substrate such as copper or platinum. If working in this particular range, optimum pore diameter distributions can be obtained and there are no problems in relation with tearing of the resulting membrane. If another gas is present in the step c) this is typically an inert gas, preferably a noble gas such as argon.

The step of thermal annealing in step c) may preferably take place either under an essentially pure oxygen atmosphere with a pressure of less than 5 mbar, preferably in the range of 0.5-4 mbar or the step of thermal annealing in step c) takes place under an essentially pure hydrogen atmosphere with a pressure of less than 5 mbar, preferably in the range of 0.01-1 mbar, most preferably in the range of 0.1-0.3 mbar.

The step of thermal annealing in step c), preferably under an oxygen atmosphere, preferably takes place at a temperature in the range of 280-350° C., preferably in the range of 290-320° C., most preferably in the range of 300° C.±5° C. A particularly preferred set of process conditions is working in the range of 300° C.±5° C. under pure oxygen atmosphere with an oxygen pressure in the range of 0.8-1.2 mbar Or the step of thermal annealing in step c) takes place under pure hydrogen atmosphere with a hydrogen pressure in the range of 0.1-0.3 mbar at a temperature in the range of 600-700° C., preferably in the range of 620-690° C.

The step of thermal annealing in step c) according to another preferred embodiment takes place during a time span adapted to the targeted average pore diameter of the pores in the nano-porous membrane. The thermal annealing for example takes place preferably under an oxygen atmosphere during a time span of at least 2 minutes, preferably at least 10 minutes or 30 minutes, more preferably in the range of 10-240 minutes, or in the range of 30-120 minutes. Or further preferably the thermal annealing takes place, preferably under a hydrogen atmosphere, during a time span of less than 10 minutes, while still on a copper substrate as used in step (a), or during a time span of less than 30 seconds, while still on a platinum substrate as used in step (a).

The thermal annealing with successive growth of said pores at the defects leads to a highly controlled, essentially linear growth of the diameter D of the pores, which can be approximated, for a given temperature and oxidant partial pressure value, and as a function of the duration time t of the thermal annealing step, using the formula:

D(t)=k * t

wherein k is a factor which depends on the conditions, in particular on temperature as well as H₂ and O₂ partial pressure, respectively.

For the experimental setups as described below, for example the parameter k takes the following values:

DLG- freestanding, at 300° C., 1.0 mbar O₂: k =0.05 nm/min (experimental Scheme 1 given below).

SLG-Pt, at 630° C., 0.18 mbar H_{2:} k=134 nm/min (experimental Scheme 2 given below). SLG-Cu at 670° C., 0.21 mbar H₂: k=5.6 nm/min (experimental Scheme 3 given below). The nano-porous membrane further preferably consists of one single or a stack of two or three single graphene layers, optionally on a porous carrier layer, preferably a porous polymeric carrier layer. A particularly good compromise in terms of sufficient thickness and resistance to tearing under load and as little resistance for those particles to pass through the pores is if there is a stack of two graphene layers.

Preferably, step b) involves energetic ion irradiation, for example heavy ion irradiation, preferably by way of gallium ion irradiation.

Further preferably, ion irradiation in step b) takes place with an acceleration voltage in the range of 1-10, preferably 4-6 kV.

According to yet another preferred embodiment, ion irradiation in step b) takes place with a current in the range of 50-200, preferably 100-150 pA, and/or with an incidence angle in the range of 35-60°, preferably in the range of 45-55°.

The step a) of generation of a contiguous, essentially non-porous membrane with one or up to four graphene layers according to yet another preferred embodiment involves a step of providing at least one nonporous single graphene layer on a copper or a platinum (or an alloy thereof) substrate, preferably a copper or platinum foil, preferably produced in a CVD process, which nonporous single graphene layer if needed is covered by a covering layer, preferably a polymer covering layer,

then the metal (e.g. copper or platinum) substrate is removed, preferably in a liquid chemical etching process, followed by rinsing, and

if needed further nonporous single graphene layers are stacked thereon, preferably initially on a metal (e.g. copper or platinum) substrate removed subsequently, to form a stack of up to four graphene layers, preferably covered on one side by said covering layer.

The contiguous, essentially non-porous membrane with one or up to four graphene layers can be mounted on a perforated scaffold, preferably a perforated ceramic scaffold, if needed a covering layer located on the side facing away from the perforated scaffold is removed, preferably by thermal annealing under reducing conditions, more preferably in the gas phase under a hydrogen atmosphere. Typically then subsequently, irradiation for defect creation is carried out, preferably by irradiating from the side opposite to the perforated scaffold.

According to one preferred method, the irradiation for defect creation is carried out in a situation where the graphene layer has already been detached from the metal substrate. According to another preferred method, the irradiation for defect creation is carried out in a situation where the graphene layer is still on the metal substrate. In particular in the latter case the conditions in step c) are adjusted to high temperatures in the range of 400-750° C., while in the former case of the graphene layer being detached from the metal substrate the conditions in step c) are adjusted to comparably low temperatures in the range of 250 to less than 400° C.

The contiguous, essentially non-porous membrane with one or up to four graphene layers can be irradiated in step b), preferably in a state mounted on a substrate, preferably on a metal, preferably on a copper or platinum substrate, most preferably on a copper or platinum foil, from the side opposite to the substrate. Preferably, the resulting layer is subjected to step c), preferably in a state mounted on said substrate, and subsequently a porous carrier layer is deposited/generated/attached to the porous graphene layer, in case of the presence of a substrate on the side opposite to the substrate, and in case of the presence of a substrate subsequently the substrate is selectively removed maintaining set porous carrier layer,

Furthermore, the present invention relates to a nano porous membrane with one or up to four graphene layers, having pores in the membrane with an average pore diameter in the range of 0.3-10 nm, obtained or obtainable using a method as described above.

Such a membrane can be mounted on a porous carrier having a porosity more permeable than the membrane, wherein preferably the porous carrier is a perforated essentially non-flexible, preferably ceramic structure or a porous, essentially flexible, preferably polymeric structure.

Also, the present invention relates to the use of a membrane obtained or obtainable according to a method as described above or of a membrane as described above as a filter element, preferably as a gas-filter or dialysis filter element, most preferably for separating different types of gases, in particular for separating hydrogen from mixtures of hydrogen with other gases, such as with at least one of or two or all of helium, methane, or CO2, but also other gases and liquid solutions.

Particularly, the present in invention relates to the use of such a membrane as a dialysis filter element with an average pore diameter in the range of 5-10 nm. Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a membrane fabrication process; in a) DLG is transferred to or produced on a porous silicon nitride frame; b) shows the irradiation with energetic ions nucleating defects in controlled regions of the DLG membrane; c) shows how nucleated defects in DLG grow into pores during the oxygen etching process, while pristine DLG remains unaffected during the oxidation process; d) shows a SEM image of DLG after ion irradiation and 2 h oxygen etching showing highly porous DLG with regular pore sizes in random locations according to the ion irradiation; e) shows the same sample after oxygen treatment, however without prior ion irradiation, showing no pores within the resolution limit of SEM. f) shows a TEM image of a single nanopore etched into graphene during 2 h of selective oxygen etching; inset: Fourier transform of the TEM image shows diffraction pattern of pristine DLG structure without amorphous regions; g) shows pristine DLG after 2 h selective oxygen etching without prior defect nucleation; DLG is unaffected and stays in its pristine state with absence of atomically small defects; inset: Fourier transform shows typical diffraction pattern of DLG without amorphous regions;

FIG. 2 shows the identification of a temperature range to achieve selective oxidation of DLG after defect nucleation; a, e) show DLG post ions and 2 h oxygen etching at 250° C. stay largely non-porous; red box marks region of higher magnification image of e; b, f) show DLG post ions and 2 h oxygen etching at 300° C. showing highly porous DLG with uniform pore density and size across membrane; red box marks region of higher magnification image of f; c, g) show DLG post ions and 2 h oxidation at 350° C. showing highly porous DLG with non-uniform pore density and size across membrane; red box marks region of higher magnification image of g; d) shows the quantification of pore size distributions obtained using ImageJ for pores larger than the detection limit (red dashed line); oxidation below 300° C. results in very low pore density opposed to 300° C. oxidation; oxidation at 350° C. results in lower density of small pores compared to 300° C. oxidation and additionally significantly more pores of larger diameters compared to 300° C.; pore size distributions are log-normally distributed with 300° C. oxidation showing the steepest decay of pore count for larger pores; these membranes show the narrowest pore size distributions and pore size cut-offs; H) shows a comparison of pore density obtained in ion irradiated regions (perforated left bars) compared to control regions (solid right bars) without ion irradiation at various oxidation temperatures; the pore density of membranes etched at 300° C. is highest while also the pore density in the control region stays very low, comparable to etching at higher temperatures; the etch selectivity for membranes etched at 300° C. is the highest, while simultaneously enabling narrow pore size distribution at high pore density;

FIG. 3 shows the control of pore density by ion dose; a) shows Raman spectrum evolution for increasing ion dose irradiation before oxidation (grey) shows emergences of D-peak (1380 cm⁻¹) due to atomic defects introduced into the material; higher ion doses lead to loss of 2D peak intensity until DLG approaches a typical Raman spectrum of graphite; Raman spectra after oxidation (dashed lines) do not change significantly compared to the ion only treatment; for intermediate ion doses, both, an increase in 2D intensity and decrease D intensity suggest an increase in lattice crystallinity; post 2h oxygen etching SEM images reveal increasing pore number density for increasing ion density (b, c, d). e) shows the observed relationship between pore density after 2h oxidation with ion density pre-oxidation shows linear increase of pore density with ion density;

FIG. 4 shows the gas Transport characterization across differently treated membranes; a) shows the evolution of hydrogen permeance with different treatments showing an increase upon ion irradiation and further increase of permeance by orders of magnitude for oxygen etching of different treatment times; pure oxygen etching, without prior defect creation does not increase membrane permeance; b) shows the evolution of permeance normalized to DLG permeance for different gases, respectively; hydrogen (squares), CH₄ (diamonds), Helium (circles squares), CO₂ (triangles). Each gas increases differently relative to its prior value indicating molecular effects of permeation to dominate transport; c) shows the evolution of permselectivities; ion irradiation typically decreases permselectivities in favor of the larger gas, however short oxygen etching of 15 min can again increase the selectivity values; long oxygen etching shows again a decline in selectivities in line with loss of molecular sieving properties for 2 h oxygen etching; d) shows the evolution of mixture selectivities; treatments decrease mixture selectivity and the individual mixture selectivities differ from the permselectivities; e) shows hydrogen permeance as single gas or in the presence of other gases for 2 h oxygen etched membranes, normalized by its SG permeance; hydrogen permeance decreases in the presence of other gases, proportionally to the molecular weight of the other gas; f) shows the permeance change of He, CH₄, CO₂ in SG or gas mixture, normalized by the respective SG permeance; all gases show higher permeance in mixtures with the lighter hydrogen molecules; this observation shows transfer of linear momentum from the light and fast gas to the heavier and slower gas near the membrane pores..

FIG. 5 shows the gas transport and separation for applied pressure drops for two hour etched membranes and Robeson upper bound of all membranes; a) shows single gas permeance as function of total applied pressure drop ΔP; Helium (circles) permeance is unaffected confirming helium to permeate in a purely effusive manner; the other gases hydrogen (squares), methane (diamonds) CO₂ (triangles) show increasing permeance with higher pressure drop; this reveals additional transport pathway across the nano-pores apart from effusion; b) shows the variation of mixture selectivity with change in applied pressure drop; mixture selectivities of H₂/CH₄ and H₂/CO₂decrease for higher applied pressures (H₂/He circles, H₂/CH₄ diamonds, H₂/CO₂ triangles, and CH₄/CO₂ crosses); c) Figure of merit of hydrogen methane separation; Robeson upper bound (1 μm thick selective layer) for hydrogen methane separation; atomically thin porous graphene shows superior performance compared to state-of-the-art polymers with different permeation-separation characteristics stemming from the permeation mechanisms across nano-pores in graphene; up to three orders higher permeance for two-hour oxygen etched membranes is possible at similar selectivity with other state-of-the-art membranes (Metal-organic frameworks (MOF), zeolites, graphene oxide (GO), carbon molecular sieves (CMS). Increasing selectivities can be obtained for reduction in oxygen etch time at the cost of significantly reduced permeance with up to 9.3 H₂/CH₄ selectivity with 3000 GPU membranes;

FIG. 6 shows a protocol for gas separation graphene membrane fabrication;

FIG. 7 shows a protocol for dialysis application scale graphene membrane fabrication;

FIG. 8 shows exemplary steps of the SEM image quantification for pore size analysis using ImageJ; bottom row shows magnifications of the boxes in the respective images above; left column shows raw SEM image; middle column shows thresholded version of the raw SEM image; right column shows perimeters of the detected nano-pores in the thresholded image;

FIG. 9 shows the pore size distribution of 2 h oxygen etched membrane with 5.5 nm average pore diameter (a) and pore size distribution of a commercial dialysis membrane (b);

FIG. 10 shows the gas & calibration setup; a measurement setup for single and mixture gas permeation and separation analysis at various cross-flow rates and feed gas pressures; four gases (H₂, He, CH₄, CO₂) can be individually controlled via a mass flow controller and are flown across the membrane surface; the pressure relative to the environment is monitored with a manometer and the retentate line contains a needle valve for control of pressure drop across the membrane; argon is flowing on the permeate side of the membrane sweeping the permeated feed gases toward the mass spectrometer; b calibration setup always consists of one feed gas connected to a mass flow controller; the feed gases are diluted to 1% in Argon; the gas of interest can be diluted twice subsequently to a maximum ratio of 1:50 allowing calibration from 1% to 4 ppm;

FIG. 11 shows the detected MS signal after instability filtering; detected signal for a two hours oxygen etched membrane during a pressure study experimental series lasting 44 h; again, initial hydrogen and final hydrogen signals deviate less than 10% (dashed line);

FIG. 12 shows cross flow experiments; a single gas permeance as function of feed-flow rate; b mixture selectivity as function of cross flow rate; neither the permeances nor the mixture separation factors show a marked dependence on the cross-flow rate; and

FIG. 13 shows an example of sensitivity analysis of factors influencing measurement uncertainty; a relative errors in permeation measurements are below 10% of the measured value; the calibration factor a and the argon sweep flow rate contribute the most to measurement uncertainty with 5% and ca. 2% b Mixture separation factor uncertainty is around 10% of the measured value with the calibration factor a contributing the most.

### DESCRIPTION OF PREFERRED EMBODIMENTS

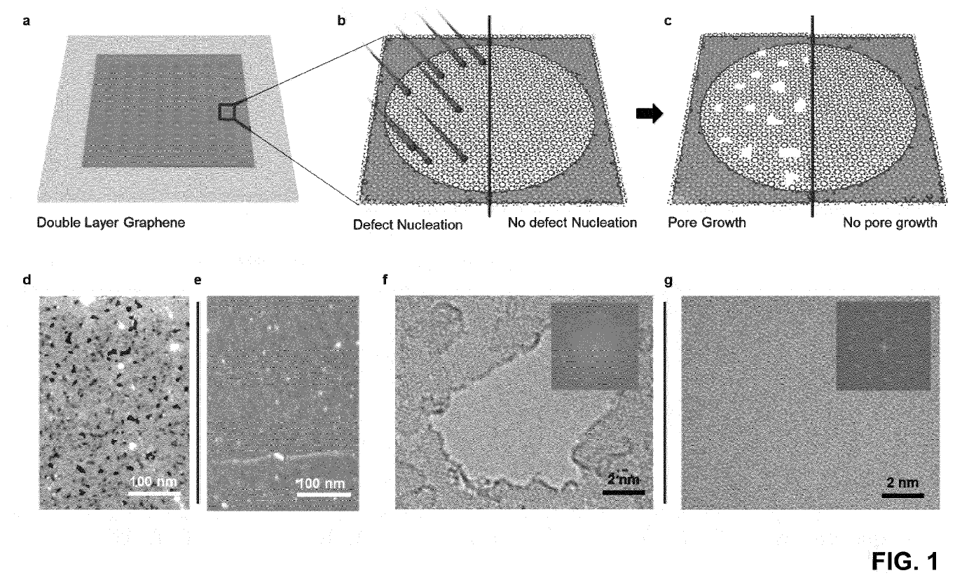

Fabrication of porous graphene membranes proceeded from DLG with initially low density of intrinsic defects and through-holes as confirmed by SEM micrographs (SI) and TEM samples (FIG. 1d-g). To enable selective etching of graphene for fabrication of highly porous membranes defects need to be introduced in a first step into the DLG. Here, unfocussed, high-energy ion irradiation is utilized. After irradiation with ions, the DLG is defective, while the size of the defects remains below the resolution limit of SEM. However, TEM imaging of DLG post ion irradiation reveals defects within the graphene lattice, which is also confirmed by Raman spectroscopy. The used defect creation technique allows precise control over the local dose of ions incident on the graphene surface and consequently the number of pores in the membrane can be controlled independently from the pore dimensions. In the second process step, annealing of the sample in oxygen at elevated temperatures selectively etches defects into nano-pores. The TEM images reveal a crystalline lattice up until the pore edge suggesting the etching approach to enable selective oxidation of carbon atoms at the edge of the graphene crystal, while the pristine crystal does not show any crystal disorder at the atomic level and consequently does not etch (see FIG. 1g).

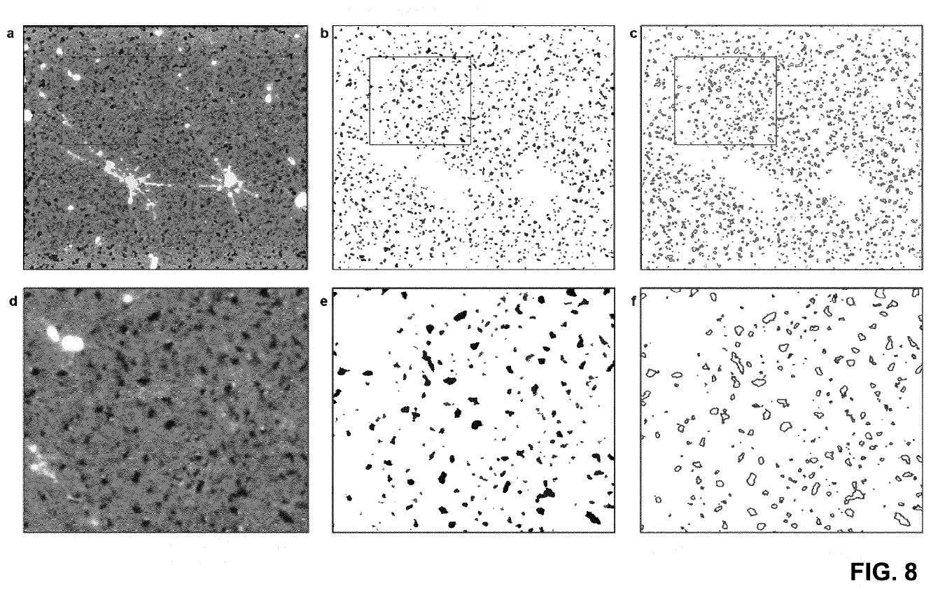

Selective oxidation of graphene edges does not occur for all conditions of temperature, pressure and gas compositions. We investigated the oxidation behavior of DLG at various temperatures and pressures. Each sample consisted of two regions: one ion irradiated region and one control region without ion irradiation. To enable qualitative and quantitative comparison, two hours of oxidation time were applied, leading to observable pores by SEM under most etching conditions. The observed pores were analyzed by ImageJ (Schneider et al. Nature Methods, 2012, 7, 671) software to obtain statistics about pore size and density of the membranes (FIG. 8). We find lower pressure of oxygen at a given temperature beneficial for selective etching, in line with theoretical ab initio simulations. We therefore chose the lower pressure limit of our system to perform a study on the temperature effect for selective oxidation, which is 1 mbar total pressure. Temperature has a strong effect on the oxidation behavior.

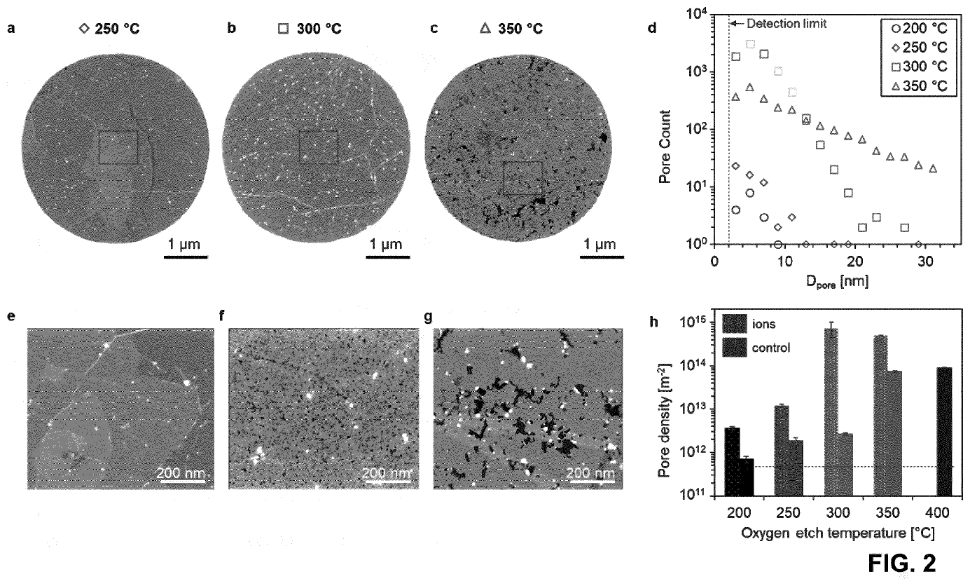

For temperatures of 250° C. and below, we do not observe pores after oxidation for both regions and furthermore the Raman spectra before and after oxidation of the control regions are indiscernible, evidencing that no nano-pores were introduced into the materials. Increasing the temperature to 300° C. leads to the emergence of a high density of nano-pores within the ion irradiated region, while the control region continues to remain non-porous and the Raman spectra before and after oxidation in the control region are indiscernible. At even higher temperatures of 350° C. the pore density in the ion region decreases and the pore size distribution becomes less narrow, to become too broad for temperatures above 400° C. The control region shows nano-pores with almost similar density as the ion region, suggesting loss of selective etching. For these temperatures also the Raman spectra before and after oxidation in the control region depict substantial increase of D/G peak ratio intensity, which supports graphene etching to start from the pristine crystal lattice. At oxidation temperatures of above 400° C. we observe complete destruction of the freestanding, ion irradiated graphene, while the control region almost completely etches. Quantitative analysis reveals log-normal pore size distributions, whenever pores in graphene can be observed (FIG. 2d). Both 250° C. and 350° C. etching temperatures show a less steep slope of relative pore size frequency as function of pore size. For 300° C. etching, the probability of having larger pores exponentially decays with pore size and furthermore the frequency/relative occurrence of outliers from a log-normal fit of the pore size distribution for 300° C. etching is the lowest. These observations suggest 300° C., 1 mbar as the optimal pair for our selective oxidation conditions to fabricate nano-porous graphene membranes with narrow pore size distributions for membrane applications without impairing presence of larger pinholes or defects.

Comparing the pore densities of both regions furthermore confirm 300° C. as optimal temperature for high etch selectivity (FIG. 2h).

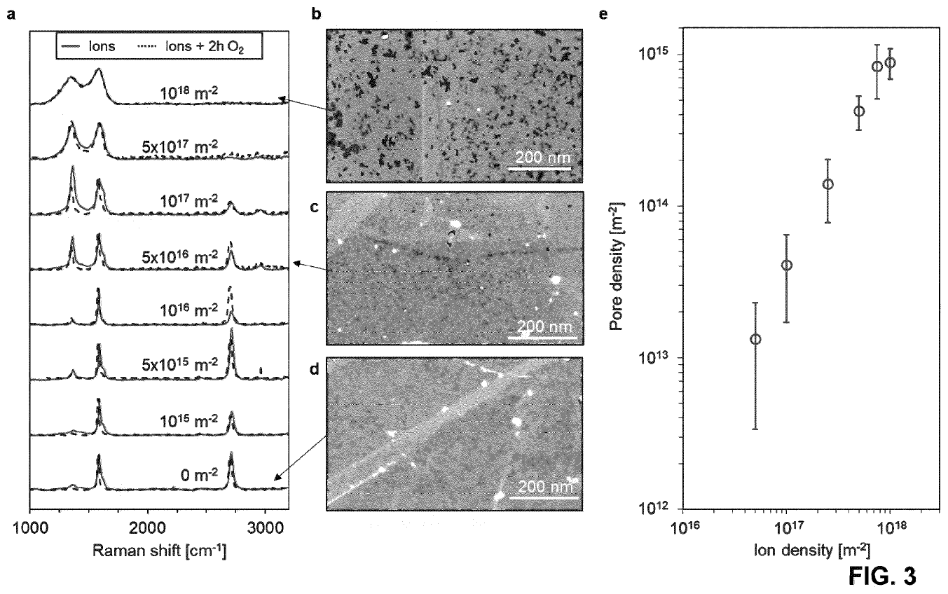

Having established the process parameters for reliable pore etching allows studying the effect of the first process step, defect creation by ion irradiation, to control the pore density of the resulting membranes. Raman spectroscopy can provide insights about the atomic structure of the graphene and about the presence of defects. The DLG membranes show a typical Raman spectrum of high-quality graphene double layers, without detectable D peak (FIG. 3a). Increasing the dose of ion irradiation gradually increases the height of the D peak, indicative of defects in the crystal lattice. In parallel the 2D peak intensity decreases until it is undetectable for ion doses above 5×10¹⁷ m⁻². Performing 1h oxidation at 300° C., 1 mbar results in the emergence of nano-pores in the samples (FIG. 3b). The pore density is found to increase proportional to the ion density, however a significant offset is found showing that even for 10¹⁶ m⁻² no pores could be observed. Increasing the ion dose further by two orders of magnitude, however, leads to a three order of magnitude increase in pore density. The found proportionality confirms the ion dose as a tuning parameter for pore density control with pore densities up to 10¹⁵ m⁻² attainable. Higher ion density lead to significant rupture of DLG before oxidation treatment, when suspended on arrays of 4 μm diameter holes.

The combination of energetic ion irradiation with subsequent annealing in mild vacuum, pure oxygen at elevated temperature was shown to selectively etch graphene at defective sites while the pristine graphene lattice is not etching. The selective etching conditions enable fabrication of highly porous graphene membranes, which allow independent control of pore size and density in a dry and scalable process. Thereby limitations of current fabrication techniques, which cannot control pore size and pore number density independently, are overcome. The slow graphene etching rates of 2-3 nm/h document the possibility of achieving smaller pores simply by reduction of oxidation time. If small enough, such pores will exhibit high selectivity for gas separation applications, while the permeability can be maximized by maximizing the number of pores within the membrane.

Gas Transport Across Porous Graphene Membranes:

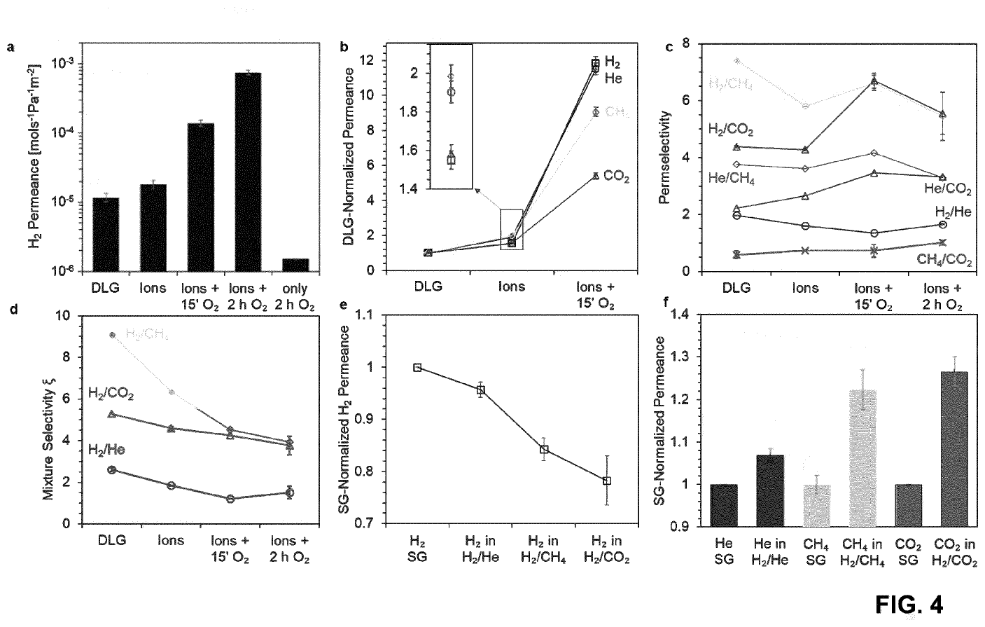

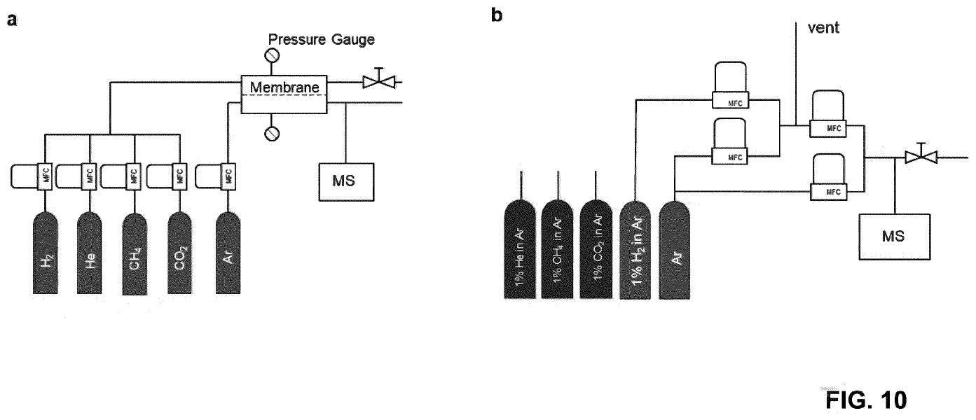

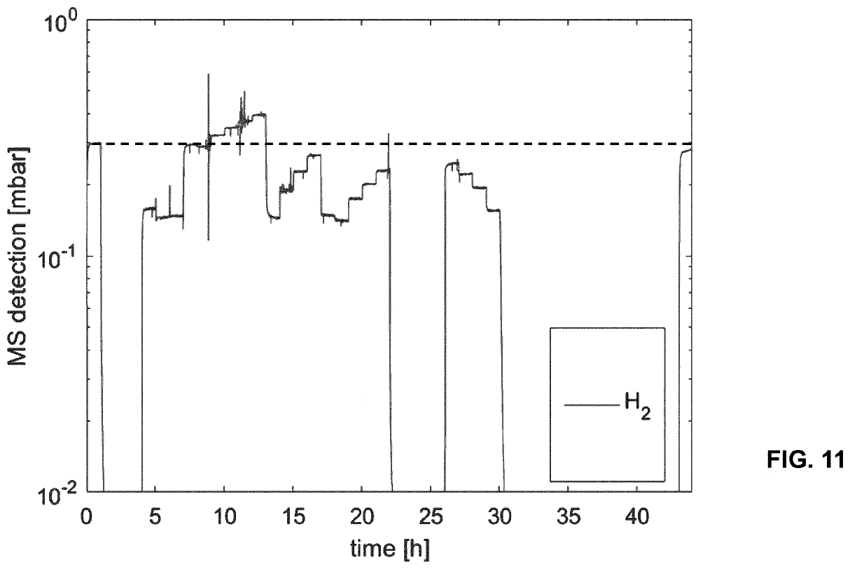

To study the gas transport through the fabricated membranes, we developed a cross-flow setup with various feed gases and analyzed the permeation using mass spectrometry (FIG. 10a). The system was calibrated to all gas types and mixtures over the entire range of measured compositions (FIG. 10b). The thin support of holey Si₃N₄ with 4 μm or 6 μm hole arrays enable to exclusively attribute measured permeance to the graphene membranes. The experiments were carried out by subsequently exposing the membranes to flows of the individual gases or mixtures. At the end of a measurement of a specific membrane, the initial gas transport experiment was repeated to test for potential changes of the membrane during the experiment. Most membranes show negligible differences in permeance even after 24 h of permeation experiments suggesting stable pore sizes and absence of membrane degradation during operation similar to other recently published studies (FIG. 11) (Yuan et al., Nano Letters, 2018, 18(8), 5057-5069). Despite using high-quality commercial graphene with low density of intrinsic defects and stacking two layers independently to cover pinholes and small defects, the so-created DLG membranes are permeable to gases (FIG. 4a). After irradiation with ions, hydrogen permeance Φ, defined as the molar flux of hydrogen normalized by its partial pressure difference across the membrane, increases slightly by less than a factor of two relative to DLG. This confirms the ion irradiation to create defects into the DLG. Subsequent etching in oxygen at 300° C. and 1 mbar for 15 min leads to a one order of magnitude increase in hydrogen permeance. As etching of graphene occurs exclusively at its defects under these conditions, we conclude that the defects from ion irradiation slightly increase their size making the membrane more permeable. Longer etching for two hours leads to a further increase in hydrogen permeance by one order of magnitude. After two hours etching in oxygen, the created pores are visible in SEM and yield an average pore size of 5.5±1.3 nm with around 1.6±0.6% porosity and unprecedented permeance (>10⁶ GPU). The permeance per-pore can be estimated for these membranes based on the SEM characterization and yields 21±6×10⁴ CO₂ s⁻¹Pa⁻⁴ near the prediction of recent MD simulations for a single 5 nm pore (≈80×10⁴ CO₂ s⁻¹Pa⁻⁴) (Yuan et al., ACS Nano, 2019, 13(10), 11809-11824). Control experiments of DLG merely exposed to two hours etching in oxygen without prior defect creation by ions does not show a higher permeance than untreated DLG and thus further confirms selective etching of graphene edges and independent control of pore number and pore size. The analysis of permeation of different gas types sheds light on the mechanism of permeation. The transport of gases is in the free molecular flow regime, if the molecules mostly scatter with the constricting geometry rather than among each other.(Blundell, Concept in thermal Physics. OUP Oxford: 2009; Hanel, D., Molekulare Gasdynamik: Einfuhrung in die kinetische Theorie der Gase and Lattice-Boltzmann-Methoden. Springer-Verlag: 2006) This is the case, if the mean free path travelled before collision with another molecule is larger than the size geometrical constriction across which the transport is occurring, as expressed by the Knudsen number. The Knudsen numbers for out experiments are typically larger than 10, placing the transport well in the free molecular flow regime and confirming applicability of free molecular flow. The first model for the molecular gas flow, J, across an infinitely thin aperture of available area, A, for transport at a partial pressure difference, P, was derived by Knudsen from kinetic theory of gases (Knudsen M., Annalen der Physik, 1909, 333, 999-1016):

$$J = \frac{AP}{\sqrt{2 π MRT}} \qquad ( 1 )$$

With the molecular weight, M, of the gas and the universal gas constant, R. The model assumes an ideal gas consisting of point particles without interaction between the molecules. Comparing the permeance Φ=J/P for each gas after ion irradiation and 15 min oxygen etching, relative to the permeance of that gas across the DLG membrane Φ_{DLG}, enables the study of the effect of ion irradiation and short oxygen etching (FIG. 4b). Based on effusion theory, the relative increase in permeance is independent of gas molecule and equal to the ratio of available open area for passage:

$$\frac{{J}_{ions}}{{J}_{DLG}} = \frac{{A}_{ions}}{{A}_{DLG}} \qquad ( 2 )$$

We measured the permeance of hydrogen, helium, methane and carbon dioxide across membranes before and after ion irradiation at room temperature and 1 bar partial pressure difference. The relative increase in permeance for each gas type is different upon ion irradiation compared to DLG ruling out the possibility of effusive transport. Instead, the assumption of point particles in effusion theory may not hold as the molecules have different spatial extent expressed by their kinetic diameter. This will have an effect when the kinetic diameter of the molecules is similar in size as the open area for passage. Such sub-nm sized defects are also known to occur for the used ion conditions in this study but using SLG (Lehtinen et al, Phys rev B 2010, 81 (15)). Treatment of DLG with ions leads to preferential increase in He permeance compared to hydrogen and carbon dioxide (CO₂). This is a signature of molecular size selectivity of the created defects toward the kinetic diameters of the different gas molecules. Thus, the created defects are inferred to be mostly smaller than the kinetic diameter of CO₂ (0.33 nm). Surprisingly, CH₄ consistently increases more than CO₂ upon ion irradiation, despite having a larger kinetic diameter. Here another mechanism of transport appears be in play to reduce the membrane passage barrier of CH₄ relative to CO₂. Potentially, differences in chemical affinity toward the pore edge may contribute to such behavior. The effect of functional chemical groups at the pore edge and their effects toward gas permeation has been subject to intense theoretical investigations (Vallejos-Burgos et al, Nature Communications, 2018, 9). The defects may be functionalized with oxygenated functional groups due to exposure to ambient air in between treatment and gas measurement. Due to their different charge distribution within the molecules, hydrogen atoms of methane could come closer to the pore edge functional group than oxygen atoms of CO2, if the pore functional group is negatively charged (Shan et al, Nanoscale 2012, 4(17), 5477-5482). Molecular dynamics simulations have indeed predicted preferential passage of the larger CH₄ over the smaller CO₂ for sub-nm pores with negatively charged pore rims.. Hence, the atomically small pore in graphene is not the same in terms of experienced permeation barrier for methane compared to CO₂. Subsequent exposure to 15 min oxygen etching, again causes the gas types to change their permeance relative to the measured permeance after ion treatment significantly. Hydrogen permeance increases almost by one order of magnitude while Helium permeance increases four-fold. Methane permeance increases six-fold and CO₂ permeance merely three-fold. Again, the differences in relative increase toward ion irradiated permeance for each gas types rules out the possibility of effusively dominated transport. Moreover, a purely size-based discrimination of the molecules does not occur. Instead, molecules containing hydrogen atoms show the most enhanced permeance and within this molecule type, the smaller molecules feature the most enhanced permeances. Similarly, there is size discrimination for molecules without hydrogen atoms (He, CO₂) which then have size-based permeances. From this analysis, we infer the pores after 15 min etching to be in the sub-nm range, sieving CO₂ from hydrogen and helium, while at the same time the pore edge chemistry significantly affects the passage barrier for the different gases.

The permselectivities of the membranes for different treatments can thus be constructed (FIG. 4c). DLG shows molecular sieving characteristics of permselectivities well above the Knudsen diffusion limit for each gas pair, given by the square root of the inverse of the molecular weights (H_{2/}He: 1.41, H₂/CH₄: 2.83, H₂/CO₂: 4.69). While permselectivity of H₂/CH₄ decreases upon ion irradiation, it increases for He/CO₂ despite CH₄ having a larger kinetic diameter than CO₂. This highlights the importance of surface chemistry on the molecular passage for sub-nm pores. Upon 15 min O₂ etching the permselectivity of H₂/CH₄ and H₂/CO₂ pairs further increases. This shows that selective oxygen etching is able to increase the membrane permeance by one order of magnitude, while simultaneously increasing permselectivity well within the molecular sieving regime. This increase in permselectivity above the Knudsen diffusion limit reveals our oxygen etching technique to tune the pore size near the differences in size of the molecules and the displays angstrom-scale precision. Longer oxygen etching durations of two hours leads to reduction of permselectivity of all gas pairs, in line with a substantial increase of the effusive transport contribution to the overall transport as would be expected for pores roughly ten times in diameter as the molecules of interest.

While the permselectivity analysis sheds light on the dominant pore size and importance of chemical functionalization for molecular-sieving-sized pores, it represents an idealization compared to real applications where mixtures of gases are always present. Therefore, mixture gas experiments were carried out for pairs of He/H₂, H₂/CH₄, and H₂/CO₂ (FIG. d). DLG membranes show molecular sieving of mixtures of H₂/CO₂ and H₂/CO₂ while He/H₂ is not sieved. This is in line with sub-nm pores with dimensions mostly smaller than CO₂. The mixture selectivities, ξ, continuously decrease upon treatment with ions and subsequent oxidation approaching values below Knudsen selectivity for H₂/CO₂ and H₂/He for 5 nm pores, which agrees with a gradual transition to lower selectivity for pores with increasing diameter (Celebi et al, Science, 2014, 344 (6181), 289-292).

For 5 nm pores the mixture selectivity is reduced below the Knudsen diffusion limit for gas pairs of H₂/He and H₂/CO₂. The permselectivity and mixture selectivity stays above the limit of Graham's law of effusion, despite having 5.5 nm pores, a result deserving further study. The selectivity values for a gas mixture are different compared to the permselectivity, indicating the presence of molecular interaction during separation of the gases by the membrane. This interaction can take place in two locations: within the volume near the membrane pore or at the surface of the membrane. Surface diffusion as an additional pathway to direct gas-phase passage is a theoretically predicted phenomenon (Sun et al., Langmuir, 2014, 30, 675-682). In the situation of a mixture of gases present at the membrane feed side, the gases adsorb competitively at the membrane surface and therefore the total amount of adsorbed gases in a mixture situation is less than in a single gas situation for each type. Consequently, the contribution from surface transport is reduced, especially for the less adsorbing gas. Competitive adsorption is predicted to be dominated by the more adsorbing gases such as CH₄ and CO₂ over H₂. Consequently, competitive adsorption is expected to reduce selectivity in a mixture for pairs such as H₂/CH₄, H₂/CO₂. At the same time, transport of linear momentum from the molecules by colliding near the membrane pores could give rise to a reduction in separation factor in favor for a slower, heavier gas present in the mixture (Present and Debethune, Physical Review 1949, 75 (7), 1050-1057). For transport without momentum transfer contribution, the permeance of each gas pair needs to be either the same or lower as in the single gas configuration since a reduced surface transport pathway is available in the mixture case. The comparison of the hydrogen permeance within a mixture of gases normalized by its single gas permeance reveals indeed a reduction in permeance for two hours oxygen etched membranes, which increases proportionally to the molecular weight of the mixture partner (FIG. 4e). However, the permeance of the respective heavier gas in a mixture with hydrogen increases above its single gas permeance (FIG. 4f). Furthermore, the increase is also proportional to the difference in molecular weight. Surface transport cannot explain this observation. Instead, transfer of linear momentum from the light gas to the heavy gas would create the observed behavior. For two-hour oxygen etched membranes with 5.5 nm average pores size, we thus conclude transfer of linear momentum to adversely affect selectivity between light and heavy gas pairs. Overall, the transport across membranes exposed to different treatments is complex and cannot be rationalized by a single dominating mechanism or transition from one mechanism to another, such as size-based molecular sieving toward weight-based effusion. Instead, pore chemistry and mixture effect affect the permeation of gases.

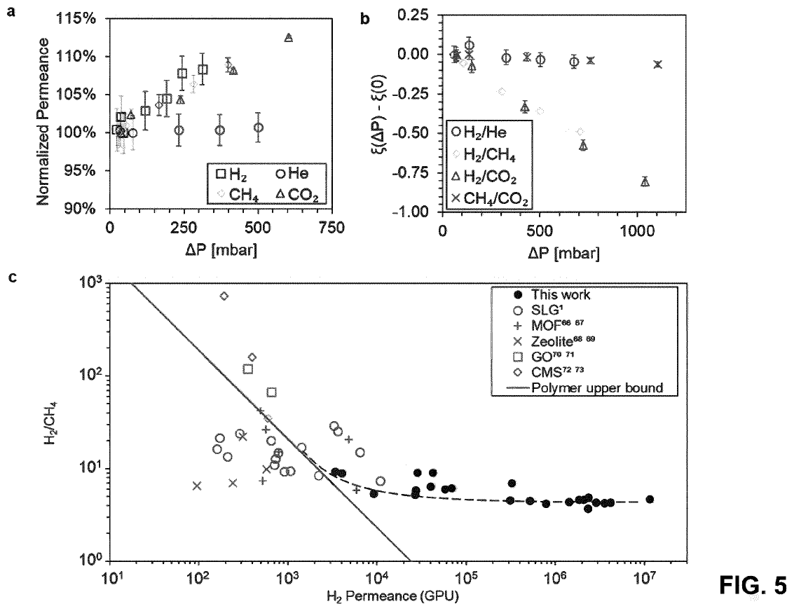

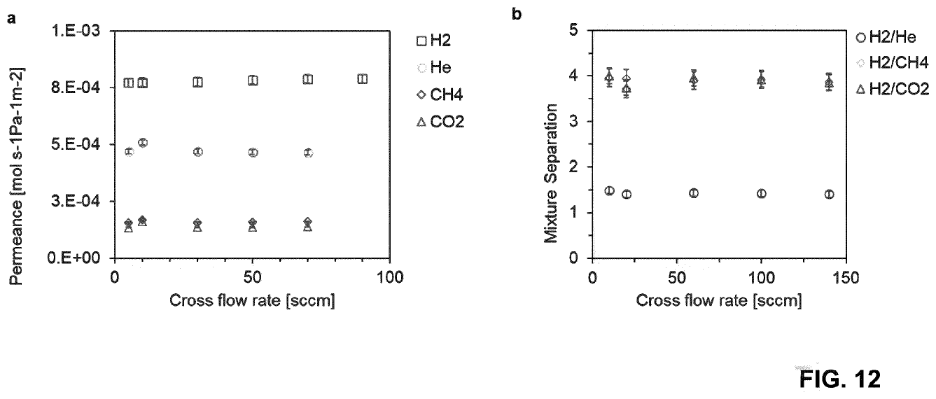

Another step toward the investigation of the membrane performance under more realistic conditions is the application of a pressure drop across the membrane and variation of the cross-flow conditions. We investigated the effect of cross-flow rate on permeance and mixture selectivity but did not see a marked effect on either (FIG. 12). Pressure application across membranes etched for two hours in oxygen, however, leads to a variation of their permeance proportional to the pressure drop, apart from helium (FIG. 5a). Purely effusive transport across a nano-pore is linearly proportional to the applied partial pressure drop and thus the permeance is independent of pressure. We observe this behavior for helium, indicating its transport to be indeed purely effusive. Furthermore, a potential pore expansion due to stretching of the membrane cannot be detected within the pressures applied based on the constant helium permeance.

The other gases display pressure dependent permeance, which implies the presence of another transport pathway. Surface diffusion is predicted to occur for adsorbing gases with potential proportionality of the gases pressure (Yuan et al, ACS Nano 2019, 13 (10), 11809-11824). We attribute the pressure dependent permeance of all gases except helium to be caused by surface diffusion, revealing yet another aspect of the rich permeation behavior of gases across nano-porous graphene membranes as predicted theoretically (Sun et al, Chemical Engineering Science 2017,138, 616-621). Furthermore, we also studied the change in mixture selectivity when increasing the total pressure drop, ΔP, across the membrane (FIG. 5b). It can be seen that the pressure drop increase leads to a significant reduction in the separation factor for gases with large ratio of molecular weights, while the separation factor in gas pairs with small molecular weight ratio stays largely unaffected.

These results further underpin the importance of transfer of linear momentum from the light to the heavy gas near the membrane pores. Ultimately, any membrane performance needs to be characterized by its selectivity and corresponding permeance (FIG. 5c). The membranes fabricated in this study exhibit unprecedented hydrogen permeance of up to 10⁷ GPU surpassing state-of-the-art graphene membranes and the upper-bound of polymers by up to three orders of magnitude at similar selectivity. Increase in selectivity is observed for membranes with short oxidation times or after ion irradiation in agreement to the predicted upper bound for a 2D porous material of a pore density of 10¹⁵ m⁻² (Yuan et al, ACS Nano 2017, 11(8), 7974-7987).

Summary and Conclusions:

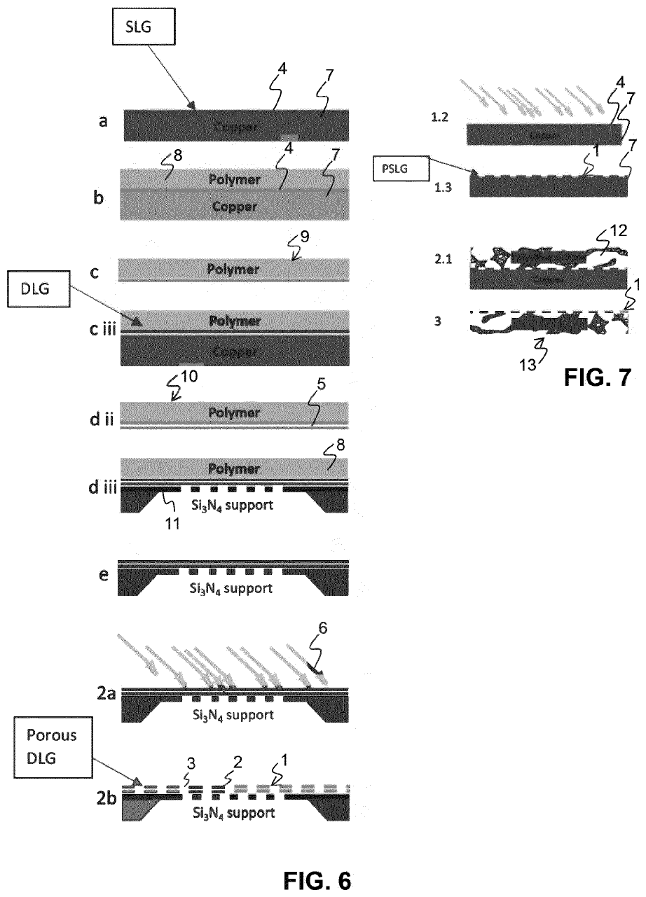

The combination of energetic ion irradiation with subsequent annealing in a pure oxygen environment at mild vacuum and elevated temperatures was shown to selectively etch and perforate graphene at defective sites, while the pristine graphene lattice is unaffected. The selective etching conditions enable fabrication of highly porous graphene membranes with independent control of pore density and size with a dry and scalable process. Hence, limitations of current fabrication techniques, which cannot control pore size and pore number density independently, are overcome. Membranes with up to three orders of magnitude higher permeance than previously reported at similar selectivity, as well as membranes with moderate permeance but higher selectivity in the molecular sieving regime were fabricated. Short etching times of 15 min enables angstrom-scale control over pore size leading to permeance increases of small gases by up to one order of magnitude, while maintaining or increasing the membrane selectivity towards gases with larger kinetic diameter. It was shown that gas transport through the nano-pores is affected collaboratively by a variety of phenomena such as molecular size, chemical affinity, surface diffusion, effusion as well as competitive adsorption and transfer of linear momentum in mixtures. The fabrication method opens avenues to fabricate large-scale nano-porous graphene membranes in a dry and facile manner with the potential to finely tune selectivity and permeance independently and to further study the various facets of gas permeation and separation across nano-porous membranes. We believe these membranes to have potential applications also in liquid-based separation ranging from osmosis to ultrafiltration. FIG. 6 schematically shows a proposed protocol for gas separation graphene membrane fabrication involving at least the following steps with the numbering as also given in FIG. 6:

1. Prepare freestanding double layer graphene
a. Single layer graphene (SLG, 4) on copper (Cu, 7) produced by CVD in situ or separately
b. Deposit polymer protective layer (e.g. PPA, 8) on SLG/Cu composite to obtain Polymer/SLG/Cu
c. Create double layer graphene (DLG) =SLG/SLG
   i. Etch Cu by floating in ammonium persulfate (APS) solution
   ii. Rinse in water
   iii. Fish Polymer/SLG (9) floating on water surface with second piece of SLG/Cu to obtain Polymer/SLG/SLG/Cu (10)
   iv. Drying in air for 60 min.
d. Transfer to substrate
   i. Etch Cu of Polymer/DLG/Cu composite (10) by floating it on APS solution
   ii. Rinse in water
   iii. Fish Polymer/DLG composite from surface with a porous Si₃N₄-membrane (11) to obtain freestanding DLG
e. Remove polymer
   i. Anneal in H₂/Ar flow (1Liter/min), 1 bar, 400° C., 2h

2. Porous membrane fabrication
a. Step 1: Introduction (6) of defects
   i. Irradiate DLG with energetic ions (e.g. 5kV acceleration voltage, 120 pA current, 5×10¹³ cm⁻² density, 52° incidence angle)
b. Step 2: grow defects into pores
   i. Thermal annealing in pure O₂ flow (e.g. 20 cm³/min), 1mbar, 300° C., various times (e.g. 2h for ca. 6 nm pores)

FIG. 7 schematically shows a proposed protocol for dialysis application scale graphene membrane fabrication for involving at least the following steps with the numbering as also given in FIG. 7:

1. Prepare porous graphene
1.1. SLG/Cu (could also be different number of layers on different substrate e.g. DLG/Platinum)
1.2. Introduce defects by ion irradiation / short plasma / ozone exposure to create defective SLG (DSLG)
1.3. Grow pores in oxygen atmosphere to obtain porous SLG (PSLG)
   1.3.1. DSLG in 02 atmosphere (for pore growth 1mbar, 300° C., but can be adapted due to presence of metal (pref. Cu) catalyst)

2. Add porous polymeric substrate to PSLG/metal (pref. Cu) composite
2.1. Perform polyether sulfone (PES) drop casting and phase inversion (PI) method on PSLG to obtain PES/PSLG/metal (pref. Cu)

3. Remove metal (pref. Cu) substrate
3.1. Lab scale method: dissolve Cu in APS
3.2. Application scale method: detach PES/PSLG by electrochemical delamination method.

Methods

Membrane Manufacturing:

Scheme 1:

Single layer graphene (SLG) from chemical vapor deposition (CVD) graphene on copper (Cu) was purchased (GrapheneA) and transferred similar to the method reported elsewhere (Celebi et al. (Science 2015, 344, 289-292)). Here, a thin protective PPA (Allresist GmbH) coating is spun on the graphene/Cu composite that is subsequently floated on a solution of ammonium persulfate (0.5 M, Sigma Aldrich). After the copper foil is dissolved, the floating PPA/SLG is transferred into a de-ionized (DI) water bath for rinsing. Next, the floating PPA/SLG composite is fished out by a second SLG/Cu to create a double layer graphene on copper. The etching in APS and rinsing in DI is repeated and the PPA/DLG composite is fished out and dried on a custom made Si₃N₄-chip containing arrays of 64 holes of 4 μm or 6 μm diameter enabling freestanding DLG membranes. The PPA layer is removed by annealing in 900 sccm H₂ and 100 sccm Ar at atmospheric pressure, 400° C. for two hours and subsequent annealing in 50 sccm H2 and 50 sccm Ar at 4 mbar pressure, 500° C. for 30 min.

Ion irradiation was executed immediately after vacuum annealing the samples. Gallium ions (FEI Helios 450) accelerated to 5 kV with 52° incidence angle were used to create defects in the freestanding DLG at various doses. Selective oxidation of the defects into pores was done for various times in a rapid thermal annealing system (Annealsys, AS-One, ca. 7 Liter chamber volume) using 1 mbar O₂ at absolute pressure of 1 mbar with 300° C., if not stated otherwise.

Scheme 2:

Single layer graphene (SLG) was produced on a platinum substrate by chemical vapor deposition (CVD) using C₂H₄ flow (0.1 cm³/min) at 900° C. and 10⁻⁴ mbar for 100 min. Ion irradiation was executed in that Gallium ions (FEI Helios 450) accelerated to 5 kV with 52° incidence angle were used to create defects in the SLG at various doses while still being on the platinum substrate. Selective oxidation of the defects into pores was done for various times in a custom-built annealing system (ca. 20 L chamber volume) using 0.18 mbar H2 at absolute pressure of 0.18 mbar with 630° C. over a time span of about 22s to generate pores having an average pore diameter in the range of 50 nm and over a time span of about 11s to generate pores having an average pore diameter in the range of 25 nm while still being on the platinum substrate.

The nano-porous membrane was separated from the platinum substrate using the following procedure: hot water immersion at 90° C. for 3h and subsequent electrochemical delamination using 0.5 M NaCI solution as electrolyte and 1.5 V.

Scheme 3:

Single layer graphene (SLG) was produced on a copper substrate by chemical vapor deposition (CVD), using C₂H₄ flow with 0.1 sccm and 4 sccm H₂ flow at 1000° C. at 2*10⁻² Pa for 30 min.

Ion irradiation was executed in that Gallium ions (FEI Helios 450) accelerated to 5 kV with 52° incidence angle were used to create defects in the SLG at various doses while still being on the copper substrate. Selective oxidation of the defects into pores was done for various times in a custom-built annealing system (ca. 20 L chamber volume) using 0.21 mbar H₂ at absolute pressure of 0.21 mbar with 670° C. over a time span of about 9 min to generate pores having an average pore diameter in the range of 50 nm and over a time span of about 4.5 min to generate pores having an average pore diameter in the range of 25 nm while still being on the copper substrate.

The nano-porous membrane was separated from the copper substrate using the same procedure in Scheme 1.

Membrane Characterization:

All membranes according to Scheme 1 were imaged in a SEM at various magnifications to rule out potential ruptures, pinholes or other defects other than the nano-pores from membrane manufacturing before measurement. The total membrane area was small enough to rule out ruptures with equivalent diameters larger than (50 nm), while pinholes and defects down to 10 nm diameter were statistically accounted for or ruled out by sampling the membrane area using higher magnification SEM micrographs. Pore size and density evaluations were done by ImageJ analysis (SI). Transmission electron microscopy (TEM) images were obtained with 80 kV acceleration (JEOL JEM-Grand300F ARM) without prior treatment omit potential changes in the membrane surface. Raman spectroscopy was done using 488 nm laser (Renishaw, inVia)

Measurement Setup:

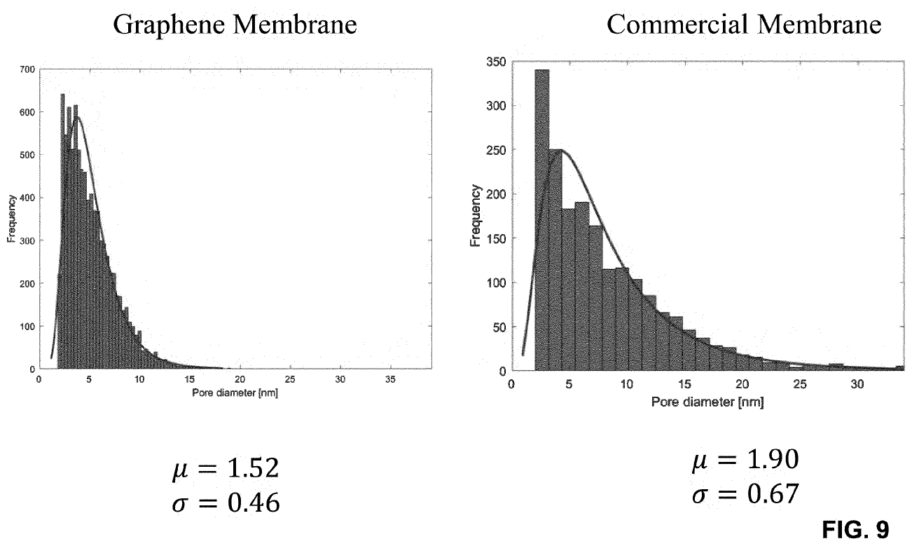

Gas permeation and mixture separation was analyzed using a mass spectrometer (MS) (Cirrus 2, MKS Instruments) and gases (Carbagas) with gas purities 5 or higher. The gas mixtures and calibration was done using mass flow controllers (MKS Instruments) in a custom build setup (FIG. 9a).

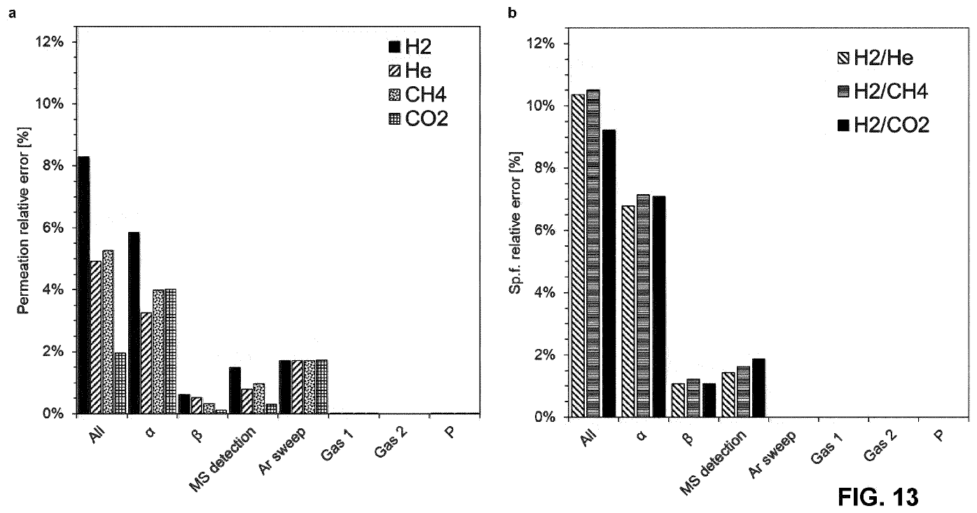

Feed gas cylinders containing pure components of either H₂, He, CH₄, or CO₂ are connected via mass flow controllers to the feed side of the membrane and can be controlled electronically. Argon is used as sweeping gas. The feed gas molecules permeate across the membrane and are diluted in the Ar sweep gas. A small probe of the resulting gas mixture is sucked into the mass spectrometer (MS) and analyzed for composition there. The lower detection limit of the system was determined to be near 1 ppm. All experiments were carried out at signal-to-noise ratios above 5 and the relative error in the measurements due to signal variation, calibration, feed composition, pressure was estimated by means of error propagation to be less than 20% for all measurements (FIG. 13).

FIG. 7 shows an experimental procedure for fabrication of porous polymeric support membrane by polyether-sulfone (PES) drop-casting and subsequent phase inversion (PI). (1.2) Defects are introduced into CVD graphene on its growth catalyst for example by means of energetic ion irradiation of oxygen plasma exposure. (1.3) synthesis of porous graphene membrane by use of the invention presented here. (2.1) Drop-casting a solution of PES and solvent, for example, dimethyl sulfoxide (DMSO) with, for example, 15%wt PES and subsequent creation of a thin-film, for example using a film applicator or spinner. Next, immersion into a non-solvent bath, for example water with or without liquid additives starts the solvent-non-solvent exchange leading to precipitation of the PES into a porous membrane structure. after removal of the growth catalyst, for example by use of chemical etching or delamination, a porous graphene membrane suspended on a porous polymeric support membrane results.

### LIST OF REFERENCE SIGNS

| | |
|---|---|
| 1 | nano-porous graphene membrane |
| 2 | single graphene layer |
| 3 | pore in 1 |
| 4 | non-porous single layer graphene |
| 5 | non-porous membrane |
| 6 | defect creating irradiation |
| 7 | copper foil |
| 8 | polymer layer |
| 9 | non-porous single layer membrane on carrier layer |
| 10 | non-porous multi layer membrane on carrier layer |
| 11 | ceramic perforated scaffold |
| 12 | porous polymeric carrier layer |
| 13 | Filter membrane |
| APS | ammonium persulfate |
| CVD | chemical vapor deposition |
| DLG | double layer graphene |
| DMSO | Dimethyl Sulfoxide |
| DSLG | defective SLG |
| FEI | Focused Ion Beam |
| PES | Polyethersulfone |
| PPA | poly(phthalaldehyde) |
| PSLG | porous SLG |
| SEM | scanning electron microscope |
| SLG | single layer graphene |
| TEM | Transmission electron microscopy |

1. Method for producing a nano-porous membrane with one or up to four graphene layers, pores in the membrane having an average pore diameter in the range of 0.2-50 nm,
wherein the method comprises the following steps:
a) generation of a contiguous, essentially non-porous membrane with one or up to four graphene layers;
b) distributed point wise defect creation in said non-porous membrane with one or up to four graphene layers by way of irradiation;
c) generation and successive growth of said pores at the defects generated in step b) by thermal annealing in the gas phase.

2. Method according to claim 1, wherein the average pore size of the pores in the nano-porous membrane is in the range of 0.3-10 nm,
or wherein the pore density in the nano-porous membrane is in the range of up to up to 10¹⁷ m⁻².

3. Method according to claim 1, wherein the step of thermal annealing in step c) takes place
either at a temperature in the range of 250° C. to less than 400° C., under an oxygen atmosphere with a partial oxygen pressure of less than 5 mbar,
or at a temperature in the range of 400° C. to less than 900° C., under a hydrogen atmosphere with a partial H2 pressure of less than 5 mbar.

4. Method according to claim 1, wherein the step of thermal annealing in step c) takes place under an essentially pure oxygen atmosphere with a pressure of less than 5 mbar,
or wherein the step of thermal annealing in step c) takes place under an essentially pure hydrogen atmosphere with a pressure of less than 5 mbar.

5. Method according to claim 1, wherein the step of thermal annealing in step c) takes place at a temperature in the range of 280-350° C.,
or wherein the step of thermal annealing in step c) takes place under pure hydrogen atmosphere with a hydrogen pressure in the range of 0.1-0.3 mbar at a temperature in the range of 600-700° C.

6. Method according to claim 1, wherein the step of thermal annealing in step c) takes place during a time span adapted to the targeted average pore size of the pores in the nano-porous membrane.

7. Method according to claim 1, wherein the nano-porous membrane consists of one single or a stack of two or three single graphene layers.

8. Method according to claim 1, wherein step b) involves energetic ion irradiation.

9. Method according to claim 1, wherein the step a) of generation of a contiguous, essentially non-porous membrane with one or up to four graphene layers involves
a step of providing at least one nonporous single graphene layer on a metal substrate,
then the metal substrate is removed, and
if needed further nonporous single graphene layers are stacked thereon, to form a stack of up to four graphene layers,
or wherein the step a) of generation of a contiguous, essentially non-porous membrane with one or up to four graphene layers involves
a step of providing at least one nonporous single graphene layer on a metal substrate which nonporous single graphene layer
if needed further nonporous single graphene layers are stacked thereon, to form a stack of up to four graphene layers,
and steps b) and c) are carried out while the graphene layers are still on said metal substrate.

10. Method according to claim 9, wherein the contiguous, essentially non-porous membrane with one or up to four graphene layers, is mounted on a perforated scaffold and wherein subsequently irradiation for defect creation is carried out.

11. Method according to claim 1, wherein the contiguous, essentially non-porous membrane with one or up to four graphene layers is irradiated in step b), the resulting layer is subjected to step c), and subsequently a porous carrier layer is deposited/generated/attached to the porous graphene layer, in case of the presence of a substrate on the side opposite to the substrate, and in case of the presence of a substrate subsequently the substrate is selectively removed maintaining set porous carrier layer.

12. Nano-porous membrane with one or up to four graphene layers, having pores in the membrane with an average pore size in the range of 0.2-50 nm, obtained or obtainable using a method according to claim 1.

13. Membrane according to claim 12 mounted on a porous carrier having a porosity more permeable than the membrane.

14. Method of using a membrane obtained or obtainable according to claim 1 or of a membrane according to claim 12 as a filter element.

15. Method of using a membrane obtained or obtainable according to claim 1 or of a membrane according to claim 12 as a dialysis filter element with an average pore size in the range of 0.2-50nm.

16. Method according to claim 1, wherein the average pore size of the pores in the nano-porous membrane is in the range of 1-9 nm, or in the range of 2-8 nm
or wherein the pore density in the nano-porous membrane is in the range of 10¹⁰ m⁻²-10¹⁶ m⁻² or in the range of 10¹² m⁻²- up to 10¹⁵ m⁻².

17. Method according to claim 1, wherein the step of thermal annealing in step c) takes place
either at a temperature in the range of 250° C. to less than 400° C., under an oxygen atmosphere with a partial oxygen pressure in the range of 0.1-4 mbar, or in the range of 0.8-1.5 mbar,
or at a temperature in the range of 600-750° C., under a hydrogen atmosphere with a partial H₂ pressure of less than 5 mbar, or in the range of 0.01-1 mbar, or in the range of 0.1-0.3 mbar.

18. Method according to claim 1, wherein the step of thermal annealing in step c) takes place under an essentially pure oxygen atmosphere with a pressure in the range of 0.5-4 mbar,
or wherein the step of thermal annealing in step c) takes place under an essentially pure hydrogen atmosphere with a pressure in the range of 0.01-1 mbar, or in the range of 0.1-0.3 mbar.

19. Method according to claim 1, wherein the step of thermal annealing in step c) takes place at a temperature in the range of 290-320° C., or in the range of 300° C.±5° C., wherein the temperature range is used under pure oxygen atmosphere with an oxygen pressure in the range of 0.8-1.2 mbar
or wherein the step of thermal annealing in step c) takes place under pure hydrogen atmosphere with a hydrogen pressure in the range of 0.1-0.3 mbar at a temperature in the range of 620-690° C.

20. Method according to claim 1, wherein the step of thermal annealing in step c) takes place during a time span adapted to the targeted average pore size of the pores in the nano-porous membrane ,
wherein the thermal annealing takes place, under an oxygen atmosphere, during a time span of at least 2 minutes, or at least 10 minutes or 30 minutes or in the range of 30-120 minutes,
or wherein the thermal annealing takes place, under a hydrogen atmosphere, during a time span of less than 10 minutes, while still on a copper substrate as used in step (a), or during a time span of less than 30 seconds, while still on a platinum substrate as used in step (a).

21. Method according to claim 1, wherein the nano-porous membrane consists of one single or a stack of two or three single graphene layers on a porous polymeric carrier layer.

22. Method according to claim 1, wherein step b) involves energetic ion irradiation in the form of heavy ion irradiation.

23. Method according to claim 1, wherein step b) involves energetic ion irradiation by way of gallium ion irradiation, wherein ion irradiation takes place with an acceleration voltage in the range of 1-10, or 4-6 kV,
or with a current in the range of 50-200, or 100-150 pA,
or with an incidence angle in the range of 35-60°, or in the range of 45-55°.

24. Method according to claim 1, wherein the step a) of generation of a contiguous, essentially non-porous membrane with one or up to four graphene layers involves
a step of providing at least one nonporous single graphene layer on a copper or platinum foil or an alloy thereof, produced in a CVD process, which nonporous single graphene layer if needed is covered by a polymer covering layer ,
then the metal substrate is removed, in a liquid chemical etching process, followed by rinsing, and
if needed further nonporous single graphene layers are stacked thereon, initially on a metal substrate removed subsequently, to form a stack of up to four graphene layers, covered on one side by said covering layer ,
or wherein the step a) of generation of a contiguous, essentially non-porous membrane with one or up to four graphene layers involves
a step of providing at least one nonporous single graphene layer on a copper or platinum foil or an alloy thereof, produced in a CVD process, which nonporous single graphene layer if needed is covered by a polymer covering layer ,
if needed further nonporous single graphene layers are stacked thereon, initially on a metal substrate removed subsequently, to form a stack of up to four graphene layers, covered on one side by said covering layer ,
and steps b) and c) are carried out while the graphene layers are still on said metal substrate.

25. Method according to claim 9, wherein the contiguous, essentially non-porous membrane with one or up to four graphene layers, is mounted on a perforated ceramic scaffold, if needed a covering layer located on the side facing away from the perforated scaffold is removed, by thermal annealing under reducing conditions, including in the gas phase under a hydrogen atmosphere, and wherein subsequently irradiation for defect creation is carried out, by irradiating from the side opposite to the perforated scaffold.

26. Method according to claim 1, wherein the contiguous, essentially non-porous membrane with one or up to four graphene layers is irradiated in step b), in a state mounted on a copper or platinum substrate or an alloy thereof, from the side opposite to the substrate, the resulting layer is subjected to step c), in a state mounted on said substrate, and subsequently a porous carrier layer is deposited/generated/attached to the porous graphene layer, on the side opposite to the substrate, and subsequently the substrate is selectively removed maintaining set porous carrier layer.

27. Membrane according to claim 12 mounted on a porous carrier having a porosity more permeable than the membrane, wherein the porous carrier is a perforated essentially non-flexible, ceramic structure or a porous, essentially flexible, polymeric structure.

28. Method according to claim 14 as a gas-filter or dialysis filter element, including for separating different types of gases.

29. Method according to claim 14 as a gas-filter filter element for separating hydrogen from other gases, including from mixtures with at least one of He, CH₄, CO₂.

30. Method according to claim 15 as a dialysis filter element with an average pore size in the range of 5-10 nm.
